(19) United States
(12) Patent Application Publication
(10) Pub. No.: US 2008/0028237 A1
(43) Pub. Date: Jan. 31, 2008

(54) Power Management Using Integrated Data and Power Interfaces

(75) Inventor: Robin Knight, Loveland, CO (US)

Correspondence Address: KRAJEC PATENT OFFICES, LLC, 820 WELCH AVENUE, BERTHOUD, CO, 80513, US

(73) Assignee: Roadnarrows, LLC, Loveland, CO (US)

(21) Appl. No.: 11/460,067

(22) Filed: Jul. 26, 2006

(51) Int. Cl. G06F 1/00

(52) U.S. Cl. 713/300

(57) ABSTRACT

A single data and power interface, or combination of several such integral data and power interfaces, are used to manage power across one or more batteries and external input power sources. In one embodiment, an interface may be capable of sinking power in order to charge a battery, and then source power from the battery through the same interface. In another embodiment, multiple devices having integrated data and power interfaces are used to manage one or more battery units for emergency power or for mobile operation where the interface may be connected to a power source for charging, but may also be used to source power from the battery to operate another device during mobile operation.

### BACKGROUND

All electronic devices that are able to communicate with other devices have the need for both power and data communication on some level. It is often desirable to integrate both power and data into a single connector and sometimes even route both power and data over the same conductors. A typical interface may include various proprietary interfaces used on cellular phones as well as standardized interfaces such as IEEE 802.3af (‘Power over Ethernet’ or ‘PoE’), IEEE 1394 (Firewire), and the Universal Serial Bus (‘USB’) interfaces.

A typical scenario is one where a device, such as a remote video camera, is powered through the same interface through which it sends data. Such cameras are commercially available and may operate using USB, Firewire, or PoE. One device, the host, sources power while the other device, the camera, sinks power. The scenario works well when the host device has a constant source of power, such as a wall outlet connected to the power grid. This design assumption has driven the design of existing interfaces and falls short in several applications, including robotic applications and other applications having multiple batteries or more complex power management issues.

### SUMMARY

A single data and power interface, or combination of several such integrated data and power interfaces, are used to manage power across one or more batteries. In one embodiment, an interface may be capable of sinking power in order to charge a battery, and then source power from the battery through the same interface. In another embodiment, multiple devices having integrated data and power interfaces are used to manage one or more battery units for emergency power or for mobile operation where the interface may be connected to a power source for charging, but may also be used to source power from the battery to operate another device during mobile operation.

A device may have an integrated data and power interface and may have a power management system that is able to detect if another device connected to the interface may source power from which the first device may charge a battery. If the other device is not capable of sourcing power, the interface may be able to detect if the other device requires power from the battery. If so, the device may configure itself to supply power to the other device. In some embodiments, the device may use electronic logic or state machines for such negotiation over the power signal lines, while in other embodiments, the various devices may communicate through the data channels for such negotiation.

In another embodiment, a device may have one interface capable of sinking power and another interface capable of sourcing power.

The devices may be configured together or with other devices in order to form a battery array that has hot-swappable properties, where one or more batteries may be removed from the system while at least one battery is connected and available to supply power.

### BRIEF DESCRIPTION OF THE DRAWINGS

In the drawings,

FIG. 1 is a pictorial illustration of an embodiment showing a system with a power management device.

FIG. 2 is a flowchart illustration of an embodiment showing a method for power management.

FIG. 3 is a diagrammatic illustration of an embodiment showing a device configured as a smart battery.

FIG. 4 is a diagrammatic illustration of an embodiment showing a system with ‘hot-swappable’ batteries.

FIG. 5 is a diagrammatic illustration of an embodiment showing a system with batteries arranged in ‘series’.

FIG. 6 is a diagrammatic illustration of an embodiment showing a system with batteries arranged in a hub arrangement.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

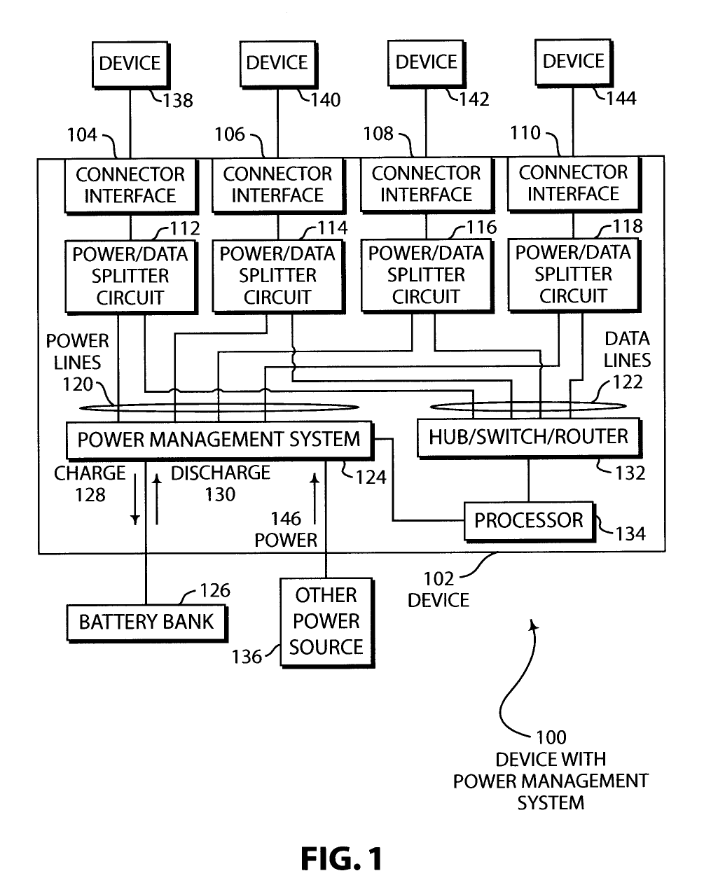

FIG. 1 is a diagram of an embodiment 100 showing a system for managing battery power. The device 102 has several connector interfaces 104, 106, 108, and 110. Each of the connector interfaces is individually and respectively connected to a power/data splitter circuit 112, 114, 116, and 118. The various power/data splitter circuits are connected through power lines 120 to a power management system 124 and through data lines 122 to a hub/switch/router 132. The power management system 124 is connected to a battery bank 126 and controls the charge 128 and discharge 130 of the battery bank 126. The power management system 124 may be connected to an outside power source 136 that supplies power 146. The hub/switch/router 132 may be connected to a processor 134 that can communicate with the power management system 124.

Devices 138, 140, 142, and 144 are connected to device 102 through connector interfaces 104, 106, 108, and 110, respectively.

Embodiment 100 is a device that is capable of communicating power and data through a single connector to another device. In this case, four different devices may be powered and communicate data through the connector interfaces 104, 106, 108, and 110. Several different standards exist for these types of interfaces, including the Universal Serial Bus (‘USB’) standards, Firewire, and Power Over Ethernet (‘PoE’) standards. In some cases, power and data are transmitted on the same conductors, while in other cases power and data are on different conductors within the same connector. Such interfaces are useful for a wide variety of applications, including devices such as a remote camera that has data and power connections through a single USB or PoE cable. Any type of connector may be used, including an RJ-45 connector. Similarly, any type of communication protocol may be used, including Ethernet and various subsections of IEEE 802.3.

Embodiment 100 has a battery 126 and power management system 124 that may be used to store power during certain times and discharge power during other times. One example of a use may be in a robotic application where the device 102 may be mounted in a robot base platform. During a charging phase, the battery bank 126 may be charged through the outside power source 136 or through power supplied through one of the connector interfaces 104, 106, 108, and 110. When the robot is mobile, the charging source may be disconnected and the battery bank 126 may supply power to the device 102 and other connected devices.

In some embodiments, the various connector interfaces may be bi-directional, where power may be either sourced or sunk through the interface. Other embodiments may be configured to only source power or only sink power through a particular connector.

The embodiment 100 may be, for example, a portion of a laptop computer that has several connector interfaces 104, 106, 108, and 110 for powering and communicating with various external devices, such as pointing devices, cameras, speakers, or any other device that uses a combination of data and power provided through one of the connector interfaces. The battery bank 126 in this example may be integral to the laptop computer, but may be charged through power from the external power source 136 or through power supplied on one of the connector interfaces 104, 106, 108, or 110.

The embodiment 100 may be a computer system or other device wherein the battery bank 126 is an emergency backup system capable of powering the device 102 when the external power supply 136 is interrupted. In some cases, such an embodiment may be configured as an uninterruptible power supply.

The power management system 124 may be adapted to manage the power of several devices 102, 138, 140, 142, and 144. Any or all of the devices 138, 140, 142, or 144 may be able to supply power through the respective connector interfaces to charge the battery bank 126. Similarly, any of the devices 138, 140, 142, and 144 may draw power through the connector interfaces that would discharge the battery bank 126. In some cases, the power management system 124 may receive power from one or more of the remote devices, distribute power to other remote devices, and charge or discharge the battery bank 126 as appropriate. For example, if the power source is greater than the total power drain for external devices, any remaining power may be used to charge the battery bank 126. If the power source is less than the total power drain, the battery bank 126 may be discharged to supplement the power source.

In cases where the connector interfaces 104, 106, 108, or 110 are able to both sink and source power, a remote device may be able to supply power for a period of time, during which the battery bank 126 may be charged. The same remote device may then switch to a mode where the remote device can no longer source power but requires the device 102 to source power. In such a mode, the battery bank 126 may be discharged to supply power to the system.

The device 102 may operate as a hub, switch, or router for data, and the data lines 122 may be routed to a hub, switch, or router circuit 132. Data hubs, switches, and routers are known in the art and enable multiple devices to be connected to each other in various network configurations. In some embodiments, the device 102 may merely be a dedicated network connection device, while in other embodiments, the device 102 may be a portion of a computer, robot, network appliance, or other device having other substantial functionality and purposes. By having a hub, switch, or router functionality, the device 102 may connect to multiple devices and enable communication between those remote devices. Such an embodiment may be where the connector interfaces 104, 106, 108, and 110 use Ethernet-based communication protocols, such as PoE.

Some embodiments may be adapted such that each device 138, 140, 142, and 144 are in communication with the processor 134 and no direct communication between the remote devices are possible. Such an embodiment may be where the device 102 is a personal computer and the connector interfaces 104, 106, 108, and 110 are USB ports or other similar architecture. In such an embodiment, the USB devices communicate directly with the processor 134 and not with each other.

The processor 134 may be in communication with the power management system 124. In some cases, the processor 134 may be adapted to receive a command from a remote device through the data lines 122 in order to change the power configuration for the same or different ports. For example, device 138 may send a command to the processor 134 to configure the power management system 124 to supply power to connector interfaces 106, 108, and 110 and to receive power from connector 104.

In many embodiments, the power management system 124 may be able to perform various operations relating to the battery bank 126. For example the power management system 124 may be capable of detecting the presence of the battery bank 126, detecting a battery type, selecting a charge profile or discharge profile based on the battery type, determining the amount of charge and the approximate amount of time left based on the actual or typical discharge rate, or any other function relating to managing the battery bank 126.

The processor 134 may be capable of receiving and responding to data queries regarding the power management system 124. For example, a remote device 140 may be able to send a query to the processor 134 to determine the status of the battery bank 126. The processor 134 may communicate with the power management system 124 to determine a status for the battery bank 126, and the processor 134 may return the query response with the charge level or other status information regarding the battery bank 126. A status query may request data on the presence and type of the battery bank, amount of charge remaining, current charge or discharge profile, current charge or discharge rate, temperature, voltage, amperage, estimated time to discharge, number of charge/discharge cycles, or any other status item.

In some embodiments, the battery bank 126 may comprise a single battery unit, while in other embodiments, the battery bank 126 may comprise several separate battery units. A battery unit may be a single battery cell or several cells arranged in a parallel or series arrangement. The power management system 124 may be adapted to connect to and manage many such detachable battery units.

Power may be managed across multiple devices and power may be managed as a system of several devices. For example, device 138 may be initially configured to supply power from a battery source attached to device 138, and the power supply may be sufficient to power devices 140, 142, and 144. When the battery source attached to device 138 reaches a low threshold, communication through the data lines 122 may be used to reconfigure the system such that the device 102 and the battery bank 126 supplies power to the devices 140, 142, and 144. Additionally, the device 138 may switch from sourcing power to sinking power from device 102. In this manner, several devices, each having a store of power, may share power and reconfigure power delivery such that the entire system remains powered.

The power management system 124 may be capable of patching certain power connections together. For example, the power management system 124 may be capable of connecting the power supplied from device 142 to source power to device 144. In such an example, the power shared between devices 142 and 144 may be independent of other power sourced or sunk between any other the other devices in the system, including device 102.

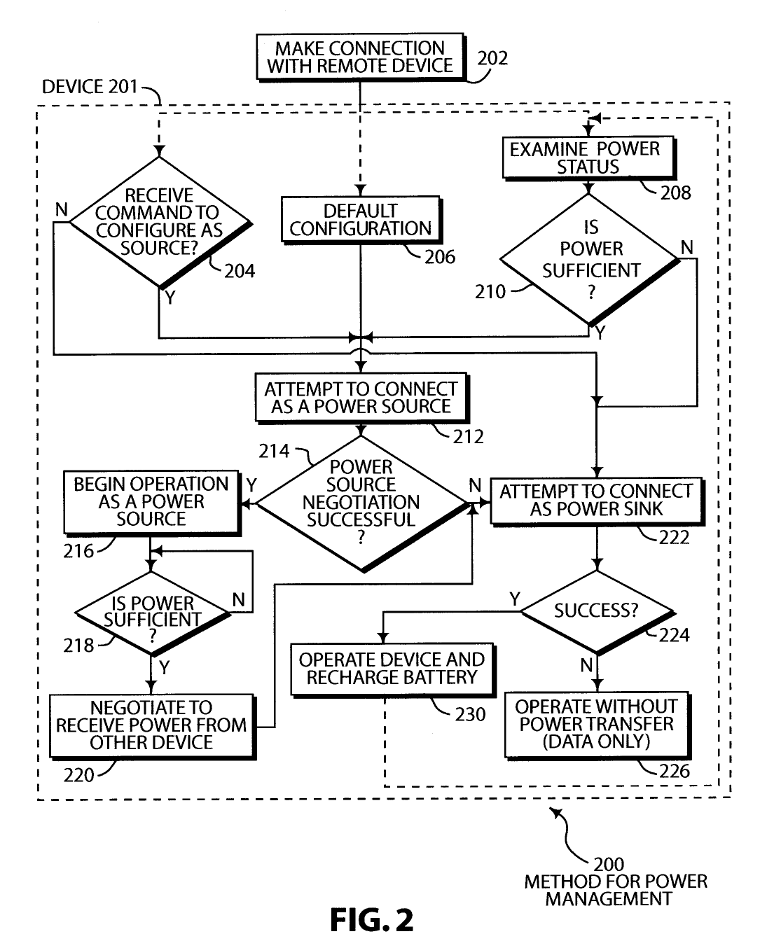

FIG. 2 is a flowchart diagram illustrating an embodiment 200 of a method for power management. When a connection is made with a remote device in block 202, three different options may happen for device 201.

In one option, the device 201 may have received a command to configure as a power source. If such command was received in block 204, the device may attempt to connect as a power source in block 212, otherwise the device may attempt to connect as a power sink in block 222.

In a second option, the default device 201 configuration of block 206 may be to attempt to configure as a power source in block 212.

In a third option, the device 201 may examine its battery or external power source status in block 208, and if the battery or external power source has sufficient power in block 210, the device 201 attempts to connect as a power source in block 212, otherwise the device 201 may attempt to connect as a power sink in block 222.

When the device 201 attempts to connect as a power source, a negotiation between the two devices may ensue. If the negotiation is successful in block 214, the device may begin operation as a power source in block 216. If the battery is low, the external power source is insufficient, or the power sources fail in block 218, the device may negotiate to receive power from another device in block 220. When the negotiation is completed, the device will attempt to connect as a power sink in block 222.

If the power source negotiation is not successful in block 214, the device may attempt to connect as a power sink in block 222. If the connection is successful in block 224, the device may operate in a power sink mode and recharge any attached batteries in block 230. The device may continue to examine the battery status in block 208 and may change from a power sink to a power source if the battery is recharged.

If the power sink negotiation is not successful in block 224, the device may operate without any power transfer in a data only mode in block 226.

The embodiment 200 illustrates a method by which devices having an integral power and data connection may configure as a power source or power sink. In some cases, commands sent via data lines may be used to configure the various devices. In such cases, the various devices may have a command set that enables one or both of the devices to send status or configuration information back and forth. Some configurations may be determined by a third device, which may be a controller device, and the third device may determine the configuration of two or more other devices.

In other cases, the negotiation may be through sensing status and communicating through the power connections. One example of such communication may be for a device to configure a specific resistance along the power connections to indicate that it may sink power. The connecting device may sense the resistance and then begin supplying power to the first device.

The embodiment 200 illustrates a method by which a device first attempts to connect as a power source, then attempts to connect as a power sink if the power source attempt fails. In other embodiments, a device may be configured to attempt to connect as a power sink initially, then attempts as a power source secondarily.

In embodiments where a device has no battery present and no external power source, the device may attempt to connect as a power sink only. If the device has no battery but does have a constant external power source, such as a wall outlet or other power connection, the device may attempt to connect as a power source but not attempt to connect as a power sink.

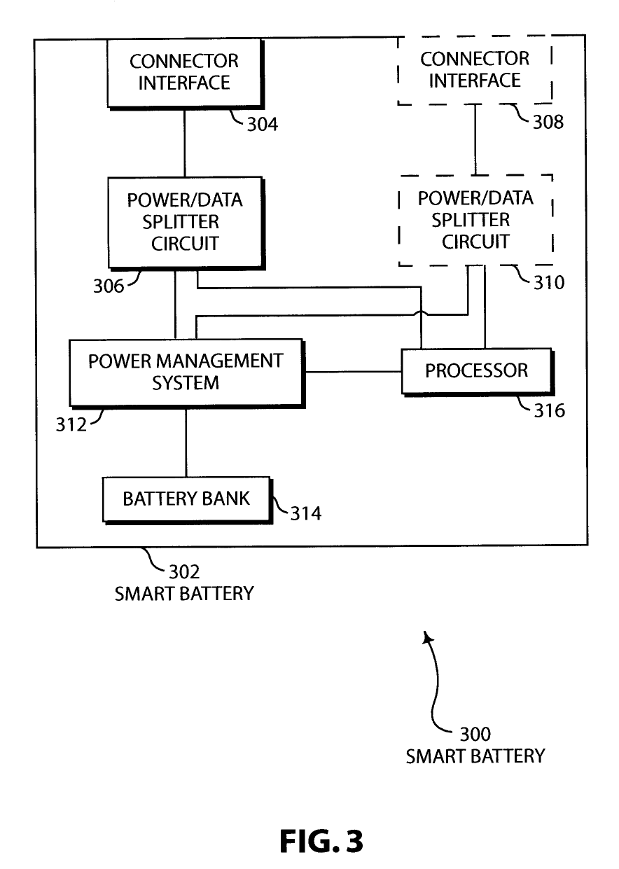

FIG. 3 is a block diagram of an embodiment 300 of a smart battery. The smart battery 302 has a connector interface 304 that is connected to a power/data splitter circuit 306. The power connection is connected to a power management system 312 which is in turn connected to a battery bank 314. Some embodiments may also have a processor 316 that is adapted to communicate on the data lines and communicate with the power management system 312. Some embodiments may also have a second connector interface 308 with a second power/data splitter circuit 310.

The embodiment 300 is a power storage system that can store and discharge power over an interface that has both data and power connections. In some embodiments, the smart battery 302 may respond to queries and commands over the data lines. The queries and commands may include returning detailed status inquiries about the battery type, charge profile, charge amount, number of charge/discharge cycles, battery temperature, or any other status information. The commands may include configuration commands such as start or stop charging, charge per a specified charge profile, start or stop discharging, discharge at a specific rate, discharge at a specific voltage or amperage, or any other configuration command.

The smart battery 302 may be controlled and monitored by other smart battery devices or a controller device. In some configurations, multiple smart batteries 302 may detect other similar devices on a network and cooperatively manage the power requirements for a network or system. In such a configuration, the batteries may cooperatively operate by having one battery or a subgroup of batteries charge or discharge during a certain period of time, with other batteries remaining on standby. One use for a cooperative network of batteries is to allow one battery to discharge so that another charged battery may be hot-swapped into the system while sufficient power is being supplied to the system to keep the system operational.

The communication between multiple smart batteries 302 may be architected such that one of the smart batteries assumes the role of a controller in the system and issues commands to other smart batteries. In other embodiments, a group of smart batteries may operate as a cooperative unit without one specific smart battery assuming the role of a controller.

In some embodiments, the smart battery 302 may operate without cooperating with any other device, and may implement a logic or method such as in embodiment 200. Such a logic may include attempting to connect to a remote device as either a power source or power sink default mode, then switching to the alternate mode if the first is not successful.

In some embodiments, the processor 316 may be a microprocessor running a software program, a state machine, hardwired logic, or any other configuration. Some embodiments may enable a network connected device to download executable code or other configuration information to the processor 316, which may be able to store such information or executable code in any type of memory device. Some embodiments may be adapted to enable the processor 316 to contact a server over the Internet and download updates, report status, or other functions.

Some embodiments may include a user interface connected to the processor 316. A user interface may consist of merely a light emitting diode (LED) or other illuminator. In other cases, a user interface may include various buttons, displays, or other user input and output devices. The user interface may give status information about the device 302 as well as allow a user to manually configure the device, including setting the device into a charge or discharge mode.

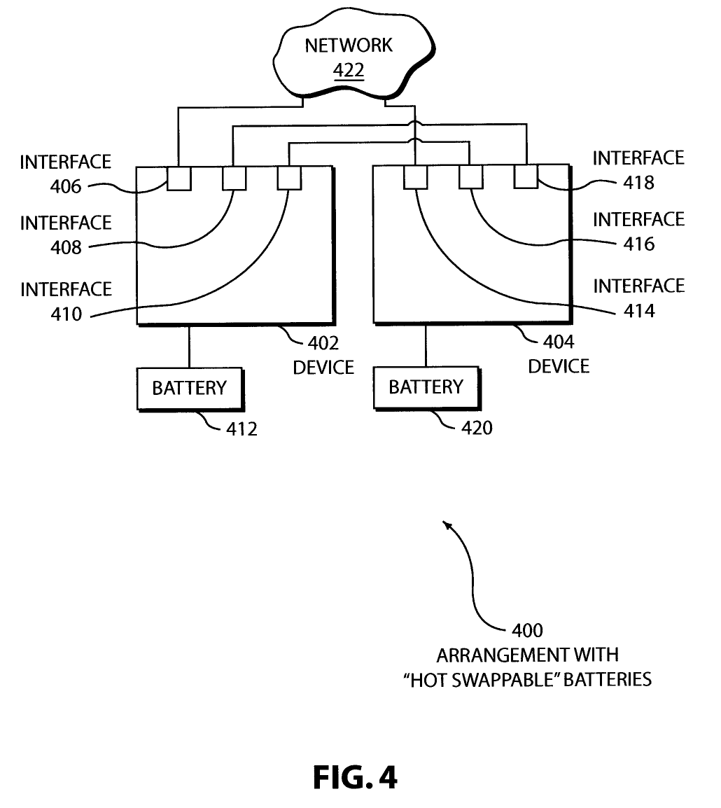

FIG. 4 is a diagrammatic illustration of an embodiment 400 showing devices with hot-swappable batteries. The devices 402 and 404 are connected together as well as to the network 422. Device 402 has interfaces 406, 408, and 412, along with an external battery 412. Device 404 may be a similar device with interfaces 414, 416, and 418 along with external battery 420. The devices 402 and 404 may provide power to operate the devices 402 and 404 as well as one or more other devices in the network 422. The interfaces 406, 408, 410, 414, 416, and 418 may be combined power and data communication interfaces.

The embodiment 400 is an example of two battery controller devices 402 and 404 that can be used together to provide a ‘hot swappable’ battery configuration. During operation, of the batteries 412 or 420 may be discharged and replaced with a replacement battery. When one of the batteries 412 or 420 goes offline during the replacement procedure, the other battery 412 or 420 may provide enough power to meet the power demand of the system.

The interfaces 406 and 414 may be connected to any type of power consuming device on the network 422. Power may be supplied through both interfaces 406 and 414. The connections between devices 402 and 404 include a connection between interfaces 408 and 418 and a connection between interfaces 410 and 416. If both interfaces 408 and 418 are able to be switchably configured as either power sourcing or power sinking, a single connection between the devices 402 and 404 may only be required. If the interfaces 408 and 418 are not switchably configurable, interfaces 408 and 416 may be power sourcing connections and interfaces 410 and 418 may be power sinking connections.

The power communication between the devices 402 and 404 may enable power routing from device 402 to 404 and from device 404 to 402. With this architecture, power can be supplied from the battery 412 to the devices 402 and 404 and out through the interfaces 406 and 414 to supply power to the entire system. Alternatively, power can be supplied from the battery 420 to the devices 404 and 402 and out through the interfaces 406 and 414. This architecture enables the devices 402 and 404 to operate as a system with one of the batteries 412 or 420 disconnected, being charged, or otherwise not supplying power to the system, while the remaining battery is used to power the entire system.

A hot swap operation may occur when, for example, the device 402 discharges the battery 412 after supplying power to the system. A handshake may occur wherein the device 404 begins to supply system power from the battery 420. After system power is being supplied from battery 420, battery 412 may be disconnected and replaced with a fully charged battery.

In some embodiments, a command or other indication may be given from a user, remote device, or one of the devices 402 or 404 to initiate the configuration of the devices 402 and 404 for a hot swap operation. In other embodiments, the devices 402 or 404 may be configured to relatively instantly and automatically detect that one of the batteries 412 or 420 have been disconnected and switch the system to a configuration where power is being continually supplied from the remaining battery. In such an embodiment, a user may disconnect and replace either of the batteries 412 or 420 at any time without having to initiate a configuration command.

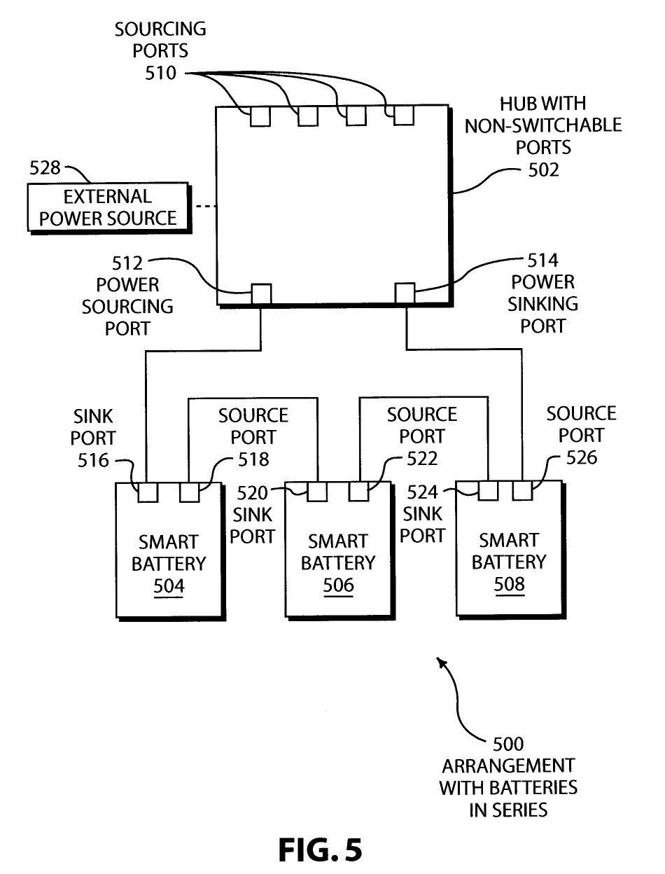

FIG. 5 is a diagrammatic illustration of an embodiment 500 showing an arrangement with batteries arranged in series. The embodiment 500 is an arrangement where the integrated power and data interfaces are not switchable from power sourcing to power sinking.

The hub 502 is connected to batteries 504, 506, and 508, which are arranged in series. The hub 502 may supply power through the sourcing ports 510 to various devices. The hub 502 has a power sourcing port 512 and a power sinking port 514 that are used to connect the batteries 504, 506, and 508 in series.

The hub's power sourcing port 512 is connected to the power sink port 516 on battery 504. The power source port 518 from battery 504 is connected to the power sink port 520 on battery 506. The power source port 522 from battery 506 is connected to the power sink port 524 on battery 508. The power source port 526 on battery 508 is connected to the power sink port 514 on hub 502. The hub 502 may also have an external power source 528, or may have one or more additional interfaces whereby power may be brought into the hub 502.

The embodiment 500 illustrates a system by which several batteries 504, 506, and 508 may be configured to supply power to the hub 502. The hub 502 may be any type of electronic device, including one adapted to supply power and data communications to several other devices. For example the hub 502 may be a laptop computer, a mobile robot, or any other type of mobile device. In another example, the hub 502 may be a desktop computer or other fixed system wherein the batteries 504, 506, and 508 are used for an emergency backup system.

When the system 500 is configured, several batteries may be attached in series. As more and more batteries are added, a larger power reserve may be available for the particular application.

Each of the batteries 504, 506, and 508 may be a smart battery similar to the embodiment 300. Thus, the batteries 504, 506, and 508 may be used in a sophisticated manner. For example, the battery power may be used from individual batteries in sequence. In one example, battery 504 may be discharged completely, then battery 506, and then battery 508 may be discharged. By discharging batteries in sequence, the first discharging battery may be completely discharged before a second battery begins the discharge cycle. This may enable a complete discharge of the first battery, which may improve the battery life over having the battery partially discharged before being recharged. In some embodiments, two or more batteries may be discharged in parallel.

The hub 502 may provide power to the batteries 504, 506, and 508 to recharge the batteries. The power used for recharging may be from the external power source 528 or from power delivered through one or more of the combination data and power ports 510. In a similar manner to the discharge mechanism, the controllable aspects of the battery functions may be used to provide optimum charge and discharge profiles for each battery.

In some cases, the batteries 504, 506, and 508 may be identical or may be different batteries with different capacities, charge profiles, discharge profiles, or other features. In such cases, certain ones of the batteries may be prioritized for discharging or charging in various situations. For example, the hub 502 may have a controller adapted to determine the configuration and status of the batteries 504, 506, and 508. The controller may sense that battery 508 has a very low capacity and may be at the end of its life. The controller may prioritize battery 508 so that battery 508 is used last in a discharge or charge sequence.

The batteries 504, 506, and 508 are connected in a ‘series’ arrangement. In practice, the output of the batteries 504, 506, and 508 may or may not be connected such that the voltage supplied by the combination of the three batteries is summed. In some embodiments, the arrangement may be configured such that a constant voltage is supplied by the batteries. The ‘series’ arrangement may refer to the general arrangement of the batteries due to the fact that the ports may be not be switchable or configurable between power sinking or power sourcing.

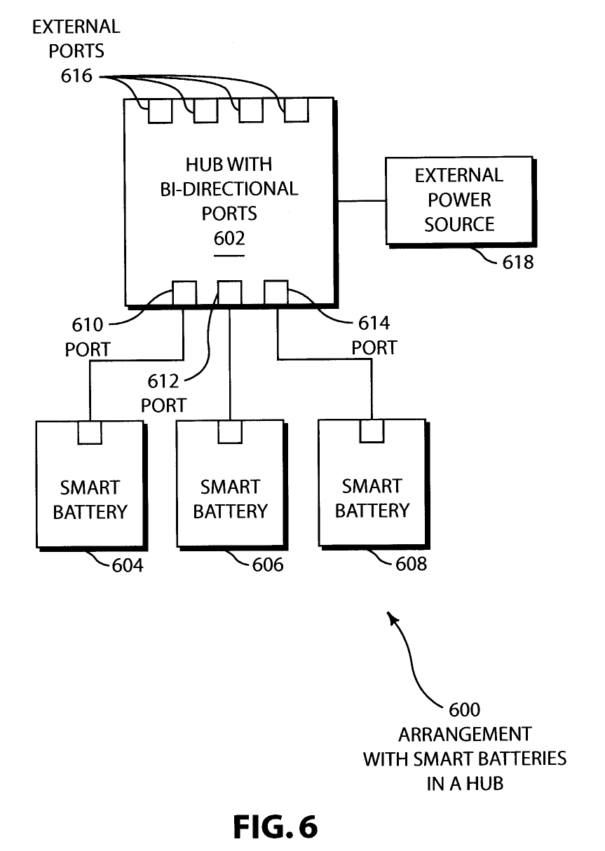

FIG. 6 is a diagrammatic illustration of an embodiment 600 showing an arrangement having multiple batteries in a hub-type arrangement using ports with switchable power sourcing or sinking. The hub 602 is connected to smart batteries 604, 606, and 608 through ports 610, 612, and 614, respectively. The hub 602 has external ports 616 and an external power supply 618.

Embodiment 600 is similar to embodiment 500 except that the ports or interfaces used between the batteries 604, 606, and 608 and the hub 602 may be capable of bi-directional power transfer. The batteries 604, 606, and 608 may be charged when the hub 602 supplies power to the batteries from the external power source 618 or power supplied through one of the ports 616. One or more of the batteries 604, 606, and 608 may also be discharged and supply power to the hub 602 and one or more of the ports 616.

The configuration of embodiment 600 may be used in a hot-swappable mode where one or more of the batteries 604, 606, and 608 may be taken offline and swapped with a fully charged battery, all the while the remaining batteries are used to supply power to the hub 602. In some cases, the hub 602 or one of the batteries may initiate the hot-swap sequence and switch a battery into a specific mode to prepare for removal and replacement. Such a case may include illuminating a light or other indicator on the hub 602 or the battery which is to be swapped. The light may be illuminated after the appropriate mode has been set on the battery and hub.

In other cases, the hub 602 may be able to detect that a battery has been removed and quickly reconfigure the remaining batteries to continually supply power to the hub 602 without suffering a low power situation.

The embodiment 600 is one example of how multiple smart batteries may be connected to a device. In some cases, the various batteries may be daisy-chained or connected so that multiple batteries can be combined to supply power to the hub 602. The embodiment 600 illustrates how the various batteries may be connected in ‘parallel’, as opposed to connecting the batteries in ‘series’ as in embodiment 500. Embodiment 600 takes advantage of the switchable or bi-directional nature of the power delivery of the ports 610, 612, and 614.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A device comprising:
a first interface comprising data communication and power communication in a first connector;
a battery bank; and
a power management system adapted to:
detect a charge level for said battery bank;
receive power input from said power communication on said first interface;
charge said battery bank using said power input;
determine that a second device connected to said first connector requires output power; and
transferring said output power from said battery to said second device through said first connector.

2. The device of claim 1 wherein said first interface is compliant with at least a subsection of IEEE 802.3.

3. The device of claim 1 wherein said first interface is an Ethernet interface.

4. The device of claim 1 wherein said power management system is further adapted to:
detect a battery type for said battery bank.

5. The device of claim 4 wherein said power management system is further adapted to:
determine a charge profile for said battery bank.

6. The device of claim 1 wherein said power management system is further adapted to:
receive a first command over said data communication; and
configure said first interface to a power source configuration based on said first command.

7. The device of claim 1 wherein said power management system is further adapted to:
receive a second command over said data communication; and
configure said first interface to a power sink configuration based on said second command.

8. The device of claim 1 further comprising:
a processor adapted to:
receive a request through said first connector, said request being a digital communication;
transmitting a response through said first connector.

9. The device of claim 1 further comprising:
a plurality of interface connections, each of said plurality of interface connections comprising data communications and power communications in a single connector.

10. The device of claim 9 wherein said plurality of interface connections being arranged in an arrangement being at least one of a group composed of: a hub arrangement, a switch arrangement, and a router arrangement.

11. A system comprising:
a first device comprising:
a first interface comprising data communication and power communication in a first connector;
a first battery bank; and
a first power management system adapted to:
detect a charge level for said first battery bank;
receive power input from said power communication on said first interface;
charge said first battery bank using said power input;
determine that a second device connected to said first connector requires output power; and
transferring said output power from said battery to said second device through said first connector;
said second device comprising:
a second interface comprising data communication and power communication in a second connector;
a second battery bank; and
a second power management system adapted to:
detect a charge level for said second battery bank;
receive power input from said power communication on said second interface;
charge said second battery bank using said power input;
determine that said first device connected to said second connector requires output power; and
transferring said output power from said second battery bank to said first device through said second connector.

12. The system of claim 11 wherein at least one of said first interface or said second interface is compliant with at least a subsection of IEEE 802.3.

13. The system of claim 12 wherein at least one of said first connector or said second connector is an RJ-45 connector.

14. The system of claim 11 wherein said first power management system is further adapted to:
detect a battery type for said first battery bank.

15. The system of claim 14 wherein said first power management system is further adapted to:
determine a charge profile for said first battery bank.

16. The system of claim 11 wherein said first device further comprises:
a processor adapted to:
receive a request through said first connector, said request being a digital communication;
transmitting a response through said first connector.

17. The system of claim 11 wherein said first device further comprises:
a plurality of interface connections, each of said plurality of interface connections comprising data communications and power communications in a single connector.

18. The system of claim 17 wherein said plurality of interface connections being arranged in an arrangement being at least one of a group composed of: a hub arrangement, a switch arrangement, and a router arrangement.
